(19) United States
(12) Patent Application Publication
(10) Pub. No.: US 2012/0079434 A1
(43) Pub. Date: Mar. 29, 2012

(54) DEVICE AND METHOD FOR PRODUCING THREE-DIMENSIONAL CONTENT FOR PORTABLE DEVICES

(76) Inventors: Jin-He Jung, Gyeonggi-do (KR); Dae-Kyu Shin, Gyeonggi-do (KR)

(21) Appl. No.: 13/266,402

(22) PCT Filed: May 4, 2010
(86) PCT No.: PCT/KR2010/002850

§ 371 Date: Oct. 26, 2011

(30) Foreign Application Priority Data
May 4, 2009 (KR) 1020090038860

(51) Int. Cl. G06F 3/048

(52) U.S. Cl. 715/849

(57) ABSTRACT

An apparatus and a method for making three-dimensional (3D) contents production possible in a mobile terminal are provided. More particularly, an apparatus and a method for allowing a general user to easily produce 3D contents by providing an edit tool for producing 3D contents in a mobile terminal are provided. The apparatus includes an object generator. When detecting an input for transforming the 3D object, the object generator determines a 3D object transform value depending on an input strength, and applies the transform value to the 3D object.

### PRIORITY

This application claims priority to an application filed as PCT/KR2010/002850 on May 4, 2010 claiming priority of the Korean Application filed in Korean Intellectual Property Office on May 4, 2009 and assigned Serial No. 10-2009-0038860, the contents of which are incorporated herein by reference.

### BACKGROUND OF THE INVENTION

1. Field of the Invention

The present invention relates to an apparatus and a method for making three-dimensional (3D) contents production possible in a mobile terminal. More particularly, the present invention relates to an apparatus and a method for allowing a general user to easily produce 3D contents by providing an edit tool for producing 3D contents in a mobile terminal.

2. Description of the Related Art

A mobile terminal has developed to a multimedia apparatus that can provide a phonebook, a game, a Short Message Service (SMS), an Electronic (E)-mail, a morning call, a Motion Picture Expert Group Audio Layer-3 (MP3) player, a schedule management function, a digital camera, and a wireless Internet service, to provide various services. Furthermore, recently, a mobile terminal that supports a 3D object is produced, so that a user may view a 3D image as well as a 3D game. The 3D environment is universally used from a game to a general User Interface (UI), and is applied to not only a web but also a mobile terminal.

The mobile terminal supports a performance that can deal with a 3D object and provides a function of detecting a hand shape and a hand motion using a multi-touch device detecting proximity to enable typing, and a limited 3D object function such as rest pointing and scrolling.

Therefore, a user has an inconvenience of having to generate a 3D object using a 3D edit tool used in a personal computer. The 3D edit tool used in the personal computer is a professional edit tool providing an infinite degree of freedom and powerful performance and so is very difficult for a general public to use. In addition, the 3D edit tool is high priced, so that a burden in cost occurs when a user purchases it.

### SUMMARY OF THE INVENTION

The present invention is designed to address at least the above-described problems and/or disadvantages and to provide at least the advantages described below. Accordingly, an aspect of the present invention is to provide an apparatus and a method for providing an edit tool for producing 3D contents in a mobile terminal.

Another aspect of the present invention is to provide an apparatus and a method for enabling 3D object generation via a touch input in a mobile terminal.

Still another aspect of the present invention is to provide an apparatus and a method for transforming a 3D object depending on a user's touch input strength in a mobile terminal.

In accordance with an aspect of the present invention, an apparatus for generating a three dimensional (3D) object in a mobile terminal is provided. The apparatus transforms a model of the 3D object depending on a user's touch input strength.

In accordance with another aspect of the present invention, an apparatus for generating a three dimensional (3D) object in a mobile terminal is provided. The apparatus includes an object generator for, when detecting an input for transforming the 3D object, determining a 3D object transform value depending on an input strength, and applying the transform value to the 3D object.

In accordance with still another aspect of the present invention, a method for generating a three dimensional (3D) object in a mobile terminal is provided. The method includes transforming a model of the 3D object depending on a user's touch input strength.

In accordance with further another aspect of the present invention, a method for generating a three dimensional (3D) object in a mobile terminal is provided. The method includes, when detecting an input for transforming the 3D object, determining a 3D object transform value depending on an input strength, and applying the transform value to the 3D object.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating a mobile terminal that can generate a 3D object according to an exemplary embodiment of the present invention;

FIG. 2 is a flowchart illustrating a process for generating a 3D object in a mobile terminal according to an exemplary embodiment of the present invention;

FIG. 3 is a flowchart illustrating a process for generating a 3D object in a mobile terminal according to an exemplary embodiment of the present invention;

FIG. 4A is a view illustrating a mobile terminal according to an exemplary embodiment of the present invention;

FIG. 4B is a view illustrating a process for generating a 3D object in a mobile terminal according to an exemplary embodiment of the present invention;

FIG. 4C is a view illustrating a 3D object generated by a mobile terminal according to an exemplary embodiment of the present invention;

FIG. 5A is a view illustrating a mobile terminal generating a 3D object according to an exemplary embodiment of the present invention;

FIG. 5B is a view illustrating a screen for transforming a 3D object depending on a user's input in a mobile terminal according to an exemplary embodiment of the present invention; and

FIG. 5C is a view illustrating a 3D object generated by a mobile terminal according to an exemplary embodiment of the present invention.

Throughout the drawings, like reference numerals will be understood to refer to like parts, components and structures.

### DETAILED DESCRIPTION OF EMBODIMENTS OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Further the terms and words used in the following description and claims are not limited to the dictionary meanings, but are merely used by the inventor to enable a clear and consistent understanding of the present invention.

Exemplary embodiments of the present invention provide an apparatus and a method for allowing a general user to easily produce 3D contents by providing an edit tool for producing 3D contents in a mobile terminal.

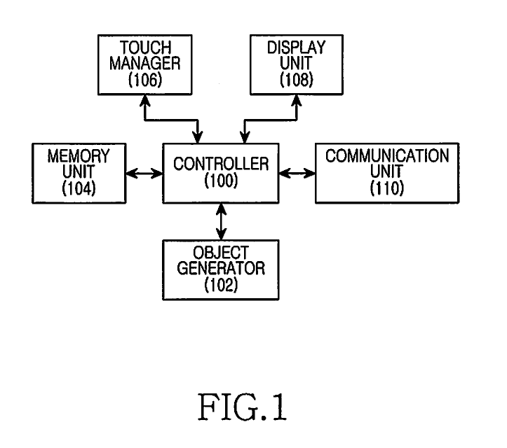

FIG. 1 is a block diagram illustrating a mobile terminal that can generate a 3D object according to an exemplary embodiment of the present invention.

Referring to FIG. 1, the mobile terminal includes a controller 100, an object generator 102, a memory unit 104, a touch manager 106, a display unit 108, and a communication unit 110. The mobile terminal may include additional units, and functionality of two or more of the above units may be integrated into a single component.

First, the controller 100 of the mobile terminal controls an overall operation of the mobile terminal. For example, the controller 100 performs processes and controls for voice communication and data communication. In addition to the general functions, according to an exemplary embodiment of the present invention, the controller 100 processes to transform the shape of a 3D object that a user desires to transform depending on the user's input strength. That is, when detecting the user's touch input, the controller 100 allows the object generator 102 to determine strength (pressure) of the touch input and determine an object transform value corresponding to the touch input.

After that, the controller 100 allows the object generator 102 to generate a 3D object to which the object transform value has been applied on a region detected by the touch input.

The object generator 102 of the mobile terminal determines the strength of the user's touch input under control of the controller 100, and determines an object transform value corresponding to the input strength.

After that, the object generator 102 of the mobile terminal applies the object transform value to a region where the touch input has been detected to generate an object transformed by the user's intention under control of the controller 100.

For example, the object generator 102 detects the user input and converts a pressure pressing a touch screen into “z” via an ADC, determines a corrected position (x′, y′) of a 3D object corresponding to “x”, “y”, which is a position (position that has detected a touch input) of the 3D object to be corrected, and applies a transform value “z” corresponding to the touch input pressure to the position (x′, y′) to perform rendering on the 3D object using OpenGL and DirectX.

The memory unit 104 includes Read Only Memory (ROM), Random Access Memory (RAM), a flash ROM, etc. The ROM stores microcodes of programs for processes and controls of the controller 100 and the object generator 102, and various reference data.

The RAM serves as a working memory of the controller 100 and stores temporary data that occur during execution of various programs. In addition, the flash ROM stores various updatable data for storage such as a phonebook, calling messages, received messages, and information of a user's touch input point. According to an exemplary embodiment of the present invention, the RAM stores a 3D object transform value depending on the user's input strength.

The touch manager 106 detects the user's touch input and performs an operation corresponding to the touch input under control of the controller 100. That is, when the user's touch input occurs, the touch manager 106 provides a position of a relevant point where the touch input occurs to the controller 100, or the touch manager 106 determines data corresponding to the position of the relevant point and outputs the relevant data to the display unit 108. According to an exemplary embodiment of the present invention, the touch manager 106 determines a pressure of the user's touch input to determine a touch input strength. Accordingly, the touch manager 106 includes a function that can measure a pressure with which the user presses a touch screen.

The display unit 108 displays status information generated during an operation of the mobile terminal, a limited number of characters, a large amount of moving images and still images, etc. The display unit 108 may be a color Liquid Crystal Display (LCD), an Active Mode Organic Light Emitting Diode (AMOLED). The display unit 108 may include a touch input device, and when it is applied to a touch input type mobile terminal, it can be used as an input unit.

The communication unit 110 transmits/receives a Radio Frequency (RF) signal of data input/output via an antenna (not illustrated). For example, during transmission, the communication unit 110 channel-codes and spreads data to be transmitted, and then performs an RF process on the signal to transmit the signal. During reception, the communication unit 110 converts a received RF signal into a baseband signal, and despreads and channel-decodes the baseband signal to recover data.

The function of the object generator 102 may be performed by the controller 100 of the mobile terminal. The separate configuration and illustration of the object generator 102 are an exemplary purpose only for inconvenience in description, not for limiting the scope of the present invention. It would be obvious to those skilled in the art that various modifications may be made within the scope of the present invention. For example, all functions of the object generator 102 may be processed by the controller 100.

Up to now, an apparatus for allowing a general user to easily produce 3D contents by providing an edit tool for producing 3D contents in a mobile terminal has been described. Hereinafter, a method for allowing a general user to easily produce 3D contents using the apparatus according to an exemplary embodiment of the present invention is described.

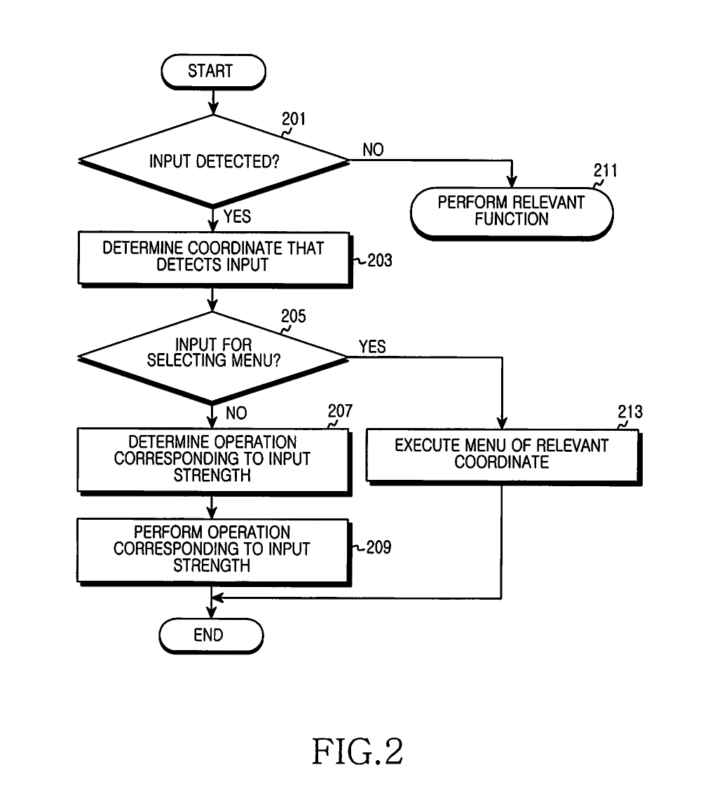

FIG. 2 is a flowchart illustrating a process for generating a 3D object in a mobile terminal according to an exemplary embodiment of the present invention.

Referring to FIG. 2, the mobile terminal determines whether a user's input is detected in step 201. Here, the user's input may be the user's touch screen input or the user's key input.

When not detecting the user's input in step 201, the mobile terminal proceeds to step 211 to perform a relevant function (for example, an idle mode).

In contrast, when detecting the user's input in step 201, the mobile terminal proceeds to step 203 to determine a coordinate that has detected the user's input, that is, a point which the user desires to input, and proceeds to step 205 to determine whether the detected input is an input for selecting a menu or an input for generating a 3D object.

At this point, the mobile terminal may determine whether the detected input is an input for selecting the menu using the user's input strength, an input maintain time, etc. For example, when detecting a short input, the mobile terminal may determine that the detected input is an input for selecting a specific menu. In contrast, when detecting a long input, the mobile terminal may determine that the detected input is an input for generating a 3D object.

When detecting the user's input for selecting the menu in step 205, the mobile terminal proceeds to step 215 to execute a menu of a relevant coordinate, and ends the present algorithm according to an exemplary embodiment of the present invention.

In contrast, when not detecting the user's input for selecting the menu in step 205, in other words, when detecting the input for generating a 3D object, the mobile terminal proceeds to step 207 to determine the user's input strength and determine an operation corresponding to the determined strength. Here, the mobile terminal stores a table representing an operation corresponding to the user's input strength in advance. The mobile terminal may determine a transform degree of a 3D object depending on the user's input strength.

The mobile terminal proceeds to step 209 to perform an operation corresponding to the input strength determined in step 207, and then ends the present algorithm.

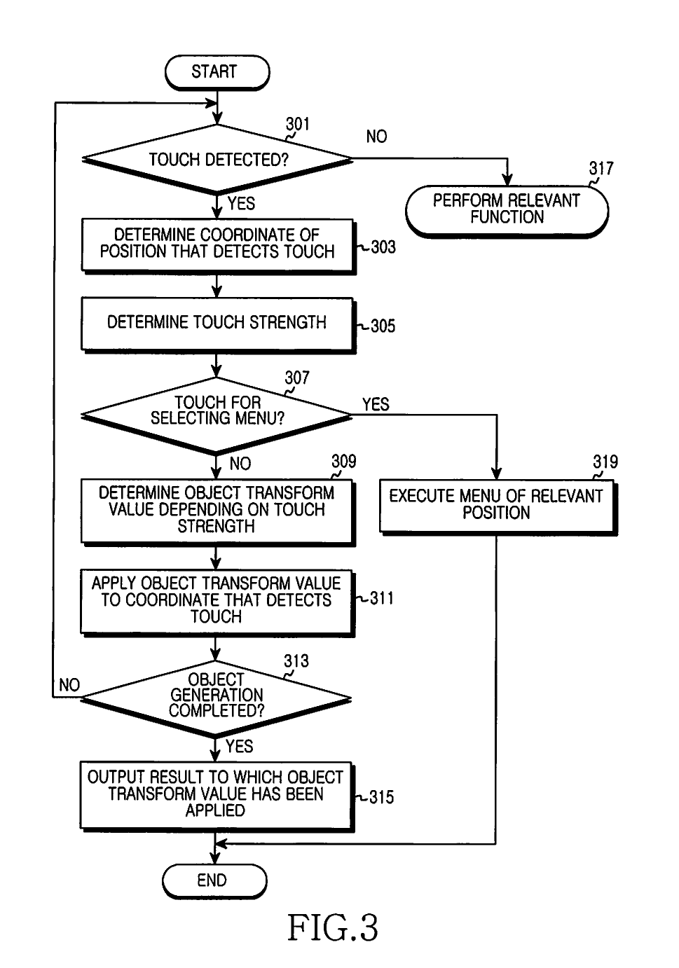

FIG. 3 is a flowchart illustrating a process for generating a 3D object in a mobile terminal according to an exemplary embodiment of the present invention.

Referring to FIG. 3, the mobile terminal determines whether a user's touch input is detected in step 301. When not detecting the user's touch input, the mobile terminal proceeds to step 317 to perform a relevant function (for example, an idle mode).

In contrast, when detecting the user's touch input, the mobile terminal proceeds to step 303 to determine a coordinate that has detected the user's touch input, and then proceeds to step 305 to determine the user's touch input strength. Here, the touch input strength may be a pressure of a touch performed by the user of the mobile terminal, a touch input maintain time, etc.

That is, when detecting the user's touch input, the mobile terminal determines a value (x, y, z) corresponding to the touch input. At this point, the user's input “x”, “y” represents a position of a 3D object to be corrected, and the user's input “z” denotes the user's touch input pressure (strength).

The mobile terminal proceeds to step 309 to determine whether the touch performed by the user is a touch for selecting a menu or a touch for generating a 3D object using the determined touch input strength. Here, as described above, the mobile terminal may determine whether the touch performed by the user is the input for selecting a menu using the strength of the user's touch input, a touch input maintain time, etc. Here, the touch for generating a 3D object is a touch for allowing the user of the mobile terminal to generate a 3D object via a touch input, and may change the shape of the 3D object depending on a touch strength.

When determining that the user of the mobile terminal has performed a touch for selecting a menu in step 307, the mobile terminal proceeds to step 319 to process to execute a menu existing at a relevant position.

In contrast, when determining that the user of the mobile terminal has not performed the touch for selecting a menu in step 307, in other words, when determining that the user of the mobile terminal has performed a touch input for generating a 3D object, the mobile terminal proceeds to step 309 to determine an object transform value depending on a touch strength. Here, the object transform value depending on the touch strength may be determined using a value for transforming a 3D object for each touch strength of the user set in advance. For example, in the case where the user intends to use a ceramics generate application, an object transform value for a weak touch is an object transform value that gives an effect like forming a ceramics with weak force when the user makes the ceramics in person. In contrast, an object transform value for a strong touch is an object transform value that gives an effect as if the user formed a ceramics with strong force.

The mobile terminal sets and stores the object transform values depending on touch strength, thereby providing a 3D object transformed depending on the user's touch strength.

The mobile terminal proceeds to step 311 to apply the object transform value to the touch detect position determined in step 303, and then proceeds to step 313 to determine whether object generation is completed. When determining that the object generation is not completed in step 313, the mobile terminal re-performs the process of step 301.

In contrast, when determining that the object generation is completed in step 313, the mobile terminal proceeds to step 315 to output the 3D object, which is a result to which the object transform value has been applied, to the display unit, and ends the present algorithm.

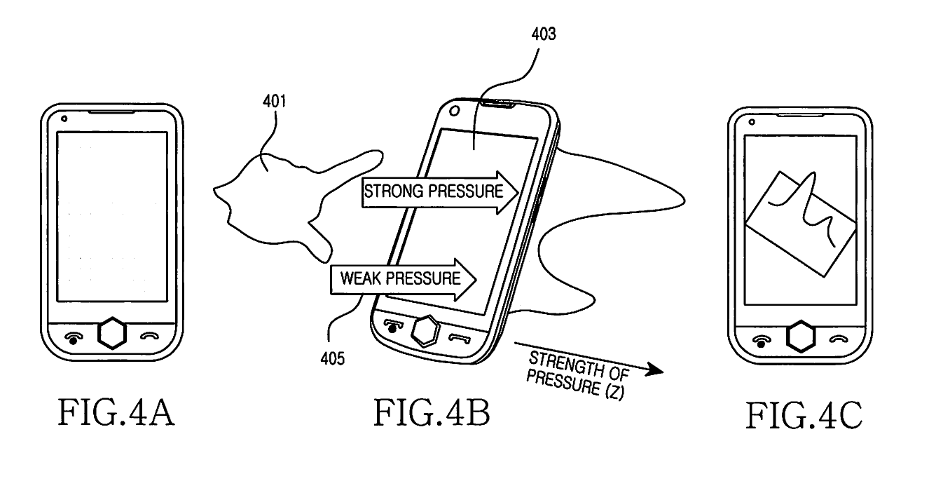

FIG. 4 is a view illustrating a process for generating a 3D object in a mobile terminal according to an exemplary embodiment of the present invention.

FIG. 4A is a view illustrating a mobile terminal according to an exemplary embodiment of the present invention.

Referring to FIG. 4A, the mobile terminal is similar to the general mobile terminal but may determine strength of a user's input.

FIG. 4B is a view illustrating a process for generating a 3D object in a mobile terminal according to an exemplary embodiment of the present invention.

Referring to FIG. 4B, the mobile terminal transforms a 3D object according to the user's input strength 401. The mobile terminal may weaken a change degree of the 3D object in response to a weak input 405, and apply a strong change degree to the 3D object in response to a strong input 403.

For example, assuming that the user uses an application that can transform a handkerchief shape, the user applies a pressure to a portion of the handkerchief, which is a 3D object, to be corrected.

Accordingly, the mobile terminal that has detected the user's strong touch input applies an effect as if the user transformed the handkerchief shape with finger force of a size corresponding to the strong touch input, and the mobile terminal that has detected the user's weak touch input may generate an object to which the user has applied an effect as if the user has transformed the handkerchief shape with weaker force than strong touch input. That is, when detecting the user's touch input, the mobile terminal determines a value (x, y, z) corresponding to the touch input and reflects the value into the 3D object.

At this point, the user's input “x” and “y” represents a position of the 3D object to be corrected, and the user's input “z” represents the user's touch input pressure (strength).

FIG. 4C is a view illustrating a 3D object generated by a mobile terminal according to an exemplary embodiment of the present invention.

Referring to FIG. 4C, as described above, the mobile terminal generates and outputs a 3D object to which an object transform value corresponding to the user's touch strength applied to the correction position of the 3D object has been applied.

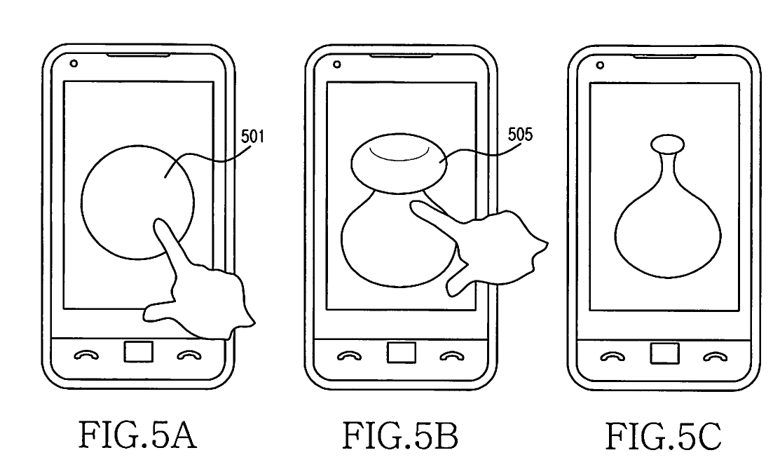

FIG. 5 is a view illustrating a process for generating a 3D object in a mobile terminal according to an exemplary embodiment of the present invention.

FIG. 5A is a view illustrating a mobile terminal generating a 3D object according to an exemplary embodiment of the present invention.

Referring to FIG. 5A, the mobile terminal is similar to the general mobile terminal but may determine the strength of a user's input. The user of the mobile terminal executes an application that generates a 3D object such as a ceramics.

Accordingly, the mobile terminal rotates an object (for example, clay) for generating a 3D object, and the user applies a pressure to the rotating object to transform the 3D object.

FIG. 5B is a view illustrating a screen for transforming a 3D object depending on a user's input in a mobile terminal according to an exemplary embodiment of the present invention.

Referring to FIG. 5B, as described above, when detecting a user's touch input while the object (for example, clay) for generating the 3D object is rotated, the mobile terminal processes (505) to transform the rotating object according to the strength of the touch input.

For example, when detecting the user's touch input from the central portion of the rotating object, the mobile terminal applies an effect of pressing the portion that has detected the user's touch input with his hand to generate a 3D object such as a gourd bottle. At this point, the mobile terminal controls (when detecting a strong touch input, applies a large change value of a curved surface which the user desires to transform, and when detecting a weak touch input, applies a small change value of the curved surface) a change value of a curved surface which the user desires to transform depending on the user's touch strength.

In addition, the mobile terminal allows the user to select an effect option such as a tool (a hammer, a gimlet, a chisel, a graver, etc.) for generating a 3D object, so that the user may apply the same effect as the option selected by the user.

FIG. 5C is a view illustrating a 3D object generated by a mobile terminal according to an exemplary embodiment of the present invention.

Referring to FIG. 5C, as described above, the mobile terminal may control a value of a curved surface which the user desires to transform depending on the user's touch input strength, so that the user may be provided with an application that cannot be provided by the conventional mobile terminal and so the mobile terminal may provide a new pleasure to the user.

As described above, the present invention allows a mobile terminal to provide an edit tool for generating a 3D object to transform the 3D object depending on a user's touch input strength, so that 3D object generation which has been impossible in the conventional mobile terminal is realized. Therefore, the user who uses the mobile terminal according to an exemplary embodiment of the present invention can easily generate a 3D object of his own and apply the same to the mobile terminal, thereby improving user's satisfaction.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An apparatus for generating a three dimensional (3D) object in a mobile terminal, wherein the apparatus transforms a model of the 3D object depending on a user's touch input strength.

2. An apparatus for generating a three dimensional (3D) object in a mobile terminal, the apparatus comprising:
an object generator for, when detecting an input for transforming the 3D object, determining a 3D object transform value depending on an input strength, and applying the object transform value to the 3D object.

3. The apparatus of claim 2, wherein the 3D object transform value depending on the input strength comprises a transform degree of the 3D object defined depending on the user's input strength.

4. The apparatus of claim 2, wherein the object generator determines strength of the input for transforming the 3D object, and determines the 3D object transform value depending on the input strength by determining a transform value corresponding to the determined input strength from 3D object transform values depending on the input strength stored in advance.

5. The apparatus of claim 2, wherein the object generator determines a region corresponding to a position at which the input for transforming the 3D object has been detected from the 3D object that is being output, and then applies a transform value to the determined region.

6. A method for generating a three dimensional (3D) object in a mobile terminal, the method comprising transforming a model of the 3D object depending on a user's touch input strength.

7. A method for generating a three dimensional (3D) object in a mobile terminal, the method comprising:
when detecting an input for transforming the 3D object, determining a 3D object transform value depending on an input strength; and
applying the object transform value to the 3D object.

8. The method of claim 7, wherein the 3D object transform value depending on the input strength comprises a transform degree of the 3D object defined depending on the user's input strength.

9. The method of claim 7, wherein the determining of the 3D object transform value depending on the input strength comprises:
determining strength of the input for transforming the 3D object; and
determining a transform value corresponding to the determined input strength from 3D object transform values depending on the input strength stored in advance.

10. The method of claim 7, wherein the applying of the transform value to the 3D object comprises:
determining a region corresponding to a position at which the input for transforming the 3D object has been detected from the 3D object that is being output; and
applying the transform value to the determined region.
